(19) United States
(12) Patent Application Publication
(10) Pub. No.: US 2025/0196412 A1
(43) Pub. Date: Jun. 19, 2025

(54) MOLD INJECTION SYSTEM AND METHODS TO PREVENT SUPERFICIAL MELT AND COLOR BLEED OF MULTI-STACK POLYMERIC DESIGNS

(71) Applicant: VALEO VISION, Bobigny (FR)

(72) Inventor: Thomas THIBAUDEAU, Seymour, IN (US)

(73) Assignee: VALEO VISION, Bobigny (FR)

(21) Appl. No.: 18/543,344

(22) Filed: Dec. 18, 2023

(51) Int. Cl. B29C 45/14; B29C 45/16

(52) U.S. Cl. CPC B29C 45/14819; B29C 45/14688; B29C 45/16; B29C 2045/1698

(57) ABSTRACT

This invention relates to the prevention and formation control of visible defects within multi-color and light-transmissive polymeric structures manufactured through multi-shot mold injection processes. The system and method can be applied to fabricate multi-layer light-transmissive products that control and eliminate visible or conspicuous defects and thus enhance the aesthetics of the associated structures such that visible defects or molded-in imperfections are effectively eliminated or not discernable to a casual observer.

### TECHNICAL FIELD

The present invention relates to improving the fabrication and appearance of light-transmissive polymeric structures in the automotive field of vehicle lighting.

### BACKGROUND OF THE INVENTION

In the automotive field of vehicle lighting, automakers seek to improve the appearance of larger scaled polymeric structures (especially larger scale multi-injection shot structures) with light transmissive characteristics that eliminate or effectively conceal visibly observable defects that form along or within the associated polymeric structures as a result of conventional manufactured processes. Remelt is a term adopted to reference a superficial melting problem during the injection process of overlaid polymeric stack layers.

Remelt or observably produced defects detract or focus attention away from the structural aesthetics and draws attention to any inconsistent defects revealed by the light that shines through at least semi-transparent mediums—observable inconsistencies that unfavorably draw attention to a conspicuous defect site. Controlling such defects on a grandiose scale by cost-effective approaches while minimizing waste has remained an elusive and a great challenge with expansive assembly structures. These problems and defects generally occur through multi-step or multi-layer mold injection processes, which contribute to the conspicuous aberrations, dimples, flashing, blurred residual constituents, bubbling, striations or similar micro-formed inconsistencies that occur within a transparent or semi-transparent structure like when located at a gate injection site of a plastic mold injector, for example.

Among the objectives, automakers demand consistently repeatable and clean light diffusive structures that are visibly free of conspicuous defects that invade larger scale integrated polymeric structures. Formulating thicker high-quality polymeric structures combinable with multi-step or multi-injection processes and that still avoid visible or conspicuous defects between the injection stages or after curing is related to this objective. A main objective is to enhance the quality of automotive scale structures through the reduction of imperfections that are perceivable by human eyes in order to enhance optical and consistent lighting effects in associated automotive lighted structures. Minimizing the risk of such customer observable defects that can be formed during the injection process of larger scaled integral structures is also a related objective of the invention, such as a unitized light-transmissive front grill-and-headlamp assembly by a non-limiting example. Another objective of the present disclosure is to control superficial melting or site aberrations between stacked polymeric layers so that the aesthetic effects are not impaired and readily exposed by light transmission through a finalized article.

### SUMMARY OF THE INVENTION

According to one aspect, a system associated with a multi-shot polymeric injection process that prevents superficial melt between deposited interfacial color layers during fabrication of a mold product, comprising: a mold that is configured to retain a number of polymeric inserts within the mold tool; a number of injectors within the mold that are configured to deposit polymeric material, where a portion of said injectors are configured to deposit a base layer with said polymeric inserts; where another portion of said injectors are configured to deposit an overlay stack of at least semi-transparent plastic such that an encapsulation region occurs of the base layer with said polymeric inserts and the overlay stack; and where the polymeric inserts are adapted to avoid remelt or color-mixing between adjoining interfaces with the base layer and the overlay stack of the mold product.

According to another aspect, a polymeric product, comprising: a base layer with an interface surface; an overlay stack with the overlay stack being in contact with a portion of the interface surface; a number of polymeric inserts positioned between the interface surface and the overlay stack where said polymeric inserts are configured to prevent melting of the base layer when the overlay stack is fabricated for the polymeric product.

According to various aspects and in examples, a method to prevent remelt along interfacial layers of a mold product during multi-injection operations of fabricating at least a semi-transparent structure, comprising: presenting a mold that retains a number of polymeric inserts within the mold; depositing a base layer of a non-transparent plastic that overlaps said polymeric inserts from a number of injector ports within the mold; depositing an overlay stack over the base layer with said polymeric inserts, such that the polymeric inserts form an absorptive barrier between the interfacial plies of the base layer and the overlay stack are configured to prevent the appearance of aberration defects in the mold product or prevent superficial melting at interfaces with the base layer and the overlay stack or configured to avoid color bleed at interfaces deposited by said injectors of the mold product.

### BRIEF DESCRIPTION OF DRAWINGS

The accompanying drawings that constitute and incorporate a part of the specification, illustrate the background or objectives and various inventive embodiments to explain these embodiments together with the description. As such, the accompanying drawings have not been necessarily drawn to scale. Any dimensional values illustrated in the accompanying graphs and figures are for illustration purposes only, which may or may not represent actual or preferred values or dimensions. Where applicable, some or all features may not be illustrated to assist in the description of underlying features. In the drawings:

FIG. 1A illustrates the result of an existing problem when a transparent polymer injection deposited over a non-transparent polymer injection that causes intermix defects.

FIG. 1B illustrates the results of a polymer injection layering process under minimal injection pressure without the applied invention where a lesser but still existing intermix defect occurs.

FIG. 1C illustrates the results of a polymer injection layering process under moderately higher nozzle pressure and temperature levels without the applied invention where a varied but still existing intermix defect outside intended edge boundaries.

FIG. 1D depicts the result of a polymer injection layering process under moderate injection pressure and lesser temperature levels without the applied invention where the layers still bleed outside and intermix across intended edge boundaries where intermix defects still occur.

FIG. 1E depicts results of a polymer injection layering process where the invention's application prevents color bleed defects or composition intermixing under various injector pressure and temperature levels to promote and maintain distinct edge boundary designs with repeatable consistency.

FIG. 2A depicts a system arrangement to apply inserts into an injection process according to an embodiment of the present invention.

FIG. 2B details a sectional view of FIG. 2A of a polymer stack that incorporates an insert according to the illustrated embodiment.

FIG. 3 illustrates a sample emplacement of injection ports at inconspicuous sites and within a decorative imprint according to an embodiment.

FIG. 4 schematically depicts a dual process for producing a clear polymeric insert in conjunction with depositing injection layers simultaneously to the injectors as regulated through runner lines according to an embodiment.

FIG. 5A illustrates an initial injection base layer formed from a non-transparent plastic for a mold product according to an embodiment of the present invention.

FIG. 5B illustrates a stack layer formed from a transparent plastic for obtaining a mold product as applied to the FIG. 5A embodiment.

FIG. 5C depicts insert placement locations prior to plastic injection operations of a transparent stack layer onto the base layer to prevent remelt defects associated with the FIG. 5B embodiment.

FIG. 5D illustrates the resultant overlay of non-transparent base layer, insert emplacements and transparent stack layer associated with the FIG. 5B embodiment.

FIG. 5E illustrates a sample sectional view associated with the FIG. 5D embodiment of the present invention.

FIG. 6 depicts an illustrative flow-chart of a mold insertion method according to an embodiment of the invention.

### DETAILED DESCRIPTION OF THE INVENTION

The present invention relates to plastic injection systems and processes in the production of multi-color polymeric structures that avoid color bleed or color melt along delineated boundaries between distinctive polymeric stacks or colorant layers. The present invention relates to plastic injection systems for the automotive field in conjunction with light-transmissive structures but is not to be limited to industrial products just within the automotive realm. The presented invention directed to polymeric mold injection systems and methods that enhance the control of defects and processes within formed polymeric structural assemblies, especially to expansive vehicle body panels. More particularly, the present invention relates to enhancements incorporated between the injection layers that address the associated problems of color bleed and remelt, which commonly occur around the injector-nozzle locations in the course of polymeric injection ply stacking.

Injection molding is a manufacturing production process that injects molten plastic material into a mold. The inventive field of this application pertains to fabrication of expansive lighted panel structures with thermoplastic and thermosetting polymers. More particularly, the present invention relates to producing expansive scale multi-color polymeric structures that avoid color bleed or superficial melt at injector areas or color mixing along delineated edge boundaries between distinctive colorant hues so that clean edge lines are repeatedly producible within a produced injection layup stack. By emplacing polymeric inserts within a multi-shot stack with strategic placement along injection gate sites, such defects can be prevented and enable the production of enhanced quality light-transmissive structures.

Generally, a multi-shot mold injection process applies elevated injection pressures and elevated temperatures during the injection-molding operation with layered encapsulation of plastic material that can cause superficial melting or interfacial damage between the interface surfaces, which can produce visibly conspicuous defects that translate into decorative features or visibly inconsistent aberrations that affect the visible aesthetics of a product. These defects become adversely viewable to observers when light is transmitted through the finalized article.

It has been observed that application of multi-color, multi-shot or multi-layer injection operations during a polymeric stack layup or an encapsulation process within a mold assembly can cause superficial melt or material bleed across layer boundaries that taint the intended design edges with a slurry of infiltrated colors or displaced material. Such contamination can hinder fabrication of quality molded products with clean delineated edges or visibly crisp design edges. The injections formed at an injection gate site with other plastic material layers can cause the superficial melting of the base layer material from shear induced factors when injection operations incorporate multi-colors that bind together a base layer with additional layer stacks.

Product defects can also be attributable to the injection process where formed aberrations are caused by uncontrolled injection steps. Such aberrations become encapsulated and become readily seen by observers upon product curing and from the application of light transmission through the produced structure. Superficial melting along or between the interfacial plastic layers during an encapsulation operation of multi-color, multi-shot or multi-layer mold injection processes can also produce conspicuous defects. Because of such uncontrolled injection processes, customers can observe visibly defective assemblies with inconsistent boundary transitions that don't appear crisp. Customers can also encounter the introduction of conspicuous aberrations within the product structure that fail quality control or visual inspections; thus, resulting in unacceptable levels of scrap and waste that is economically unfeasible and harmful to the environment.

A production of polymeric inserts that are embedded within a fabricated structural product near and along locations where mold injection ports pose the harmful risk of introducing aberrations or are likely to introduce a superficial melt problem between multi-shot injection layers or into the visible portions of the fabricated structure. With the strategic placement of injection ports at predetermined locations or at predesignated orientations, embedded defects that can arise from injector ports or gate source points can be effectively resolved by the approaches described here.

One objective is that clear-transparent inserts are placed over a non-transparent base layer or in-between different color layers such that the emplaced inserts can serve as a buffer or sacrificial layer to prevent a remelt or mixing at the interface between a clear-transparent and non-transparent color (or transparent layer of another color) during a subsequent clear injection shot application. The inserts can be formed from a clear, opaque or non-transparent polymeric composition as-is suitable to mask or absorb any resulting bleed that can occur by injection ports depositing an interfacing layer that is a different color such that intermixing is noticeable between distinct layers. The inclusion of a clear barrier insert allows the insert to melt some and mix with the subsequent injection shot (which would not be noticeable since it is clear too) instead of having the interface bleed into the base layer so that the base layer is not affected to melt or mix in a contaminating way. Accordingly, the incorporation of an insert between clear and non-clear material mixes along any interface within a polymeric injection stack would similarly prevent remelt at the interface shared by clear and non-clear layers during an injection process.

With these approaches to tackle defect problems, such associated aberrations can be effectively eliminated from the naked eye of customers and also prevent remelt or color bleed between distinctive color layers that result in unacceptable lighting products. As such, injection molded assemblies associated with this invention can be implemented in produced segregate, unitized or integrated polymeric bodies. In principle, the subject matter of the invention is presented for automotive body applications but can be used in any type of injection-molded part. Thus, associated injection molded parts can also be applied for structures extended to aerospace, civil, commercial, industrial, military or other transportation applications, by example.

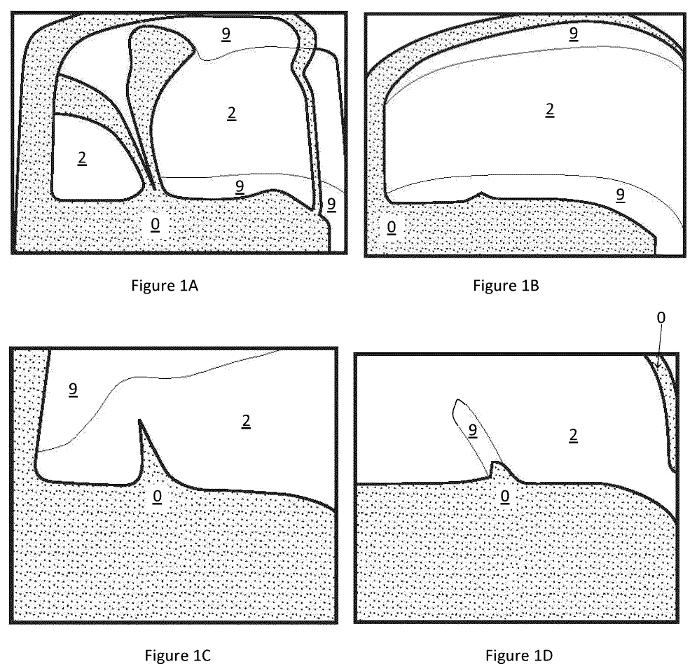

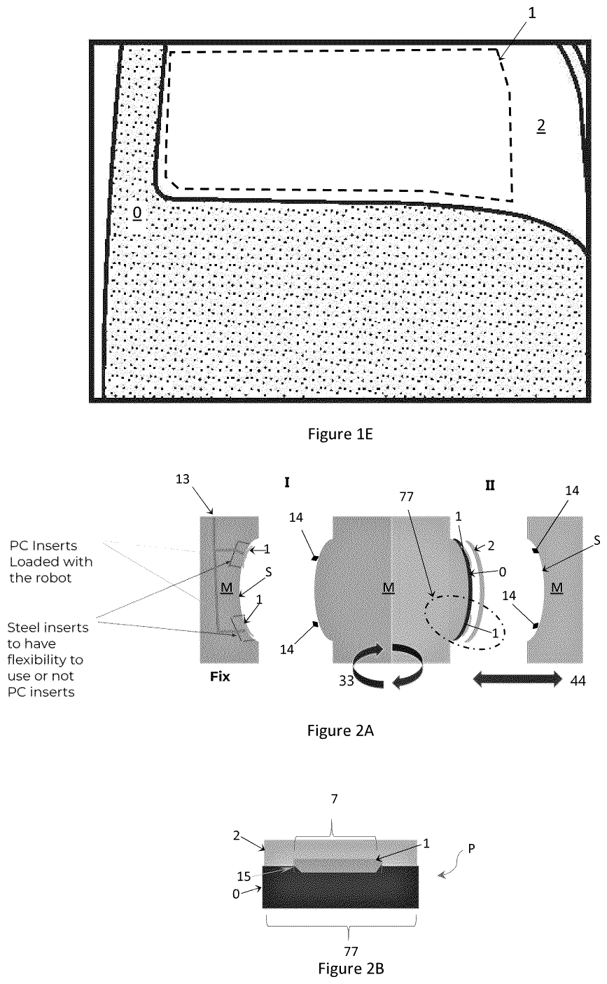

FIGS. 1A, 1B, 1C, 1D illustrate frames where conventional methods are applied (without the inventive implementation) versus where the novelty is applied according to the present invention demonstrated by FIG. 1E. The figures are viewed from the perspective of an observer looking down over a mold surface section from above while injection operations deposit and spread a base layer 0 underlayment of one color material followed by an overlapping deposit of overlay stack 2 of another see-through material or color along a horizontally planar orientation. A base layer 0 and overlay stack 2 can generally be clear, opaque, translucent or non-transparent colors that are sufficiently distinct from one another to contribute towards an inherent problem when injected over one another.

The figures depict conditions where either no in-situ insert is applied between base layer 0 and overlay stack 2 or where inconsistent results occur to some lesser degree without suitable polymeric insert 1 emplaced installation. FIG. 1E illustrates a condition where the inventive concept is successfully implemented to demonstrate repeatable results to eliminate remelt or to prevent intralayer contamination between base layer 0 and overlay stack 2 that create problems of the polymeric intermixing or bleed defects represented by remelt defect 9. Remelt defect 9 can result when a clear polymeric layer is overlaid onto a non-transparent polymeric layer where one can experience a recognized problem of intermixing or superficial melting along the interface from the consequences of being located at or near a mold injection port. An emplacement of a sacrificial layer or buffer or polymeric insert 1 between the interface of dissimilar plastic layers (inserted between base layer 0 and overlay stack 2) remediates the superficial melt problem so that the mold injected material (from injector gate 14) is absorbed into the polymeric insert 1 rather than into the interfacing layer that will show intermixing contamination. Remelt defect 9 can represent a fluidic pattern of contamination or bleed as a result of the remelt problem or undesirable mixing of a transparent deposited layer with a non-transparent injection layer.

FIG. 1A depicts the result of a clear or transparent polymer injection overlay stack 2 deposited over a non-transparent polymer injection base layer 0 following a mold injection operation without the applied insert where the distinct injection layers bleed into one another and outside intended edge boundaries causing intermix defects like remelt defect 9. The scenario reflects the overlay results of a non-transparent and transparent injection overlap under elevated pressure and temperature occurring at or near an injector gate.

FIG. 1B depicts the result of a clear polymer injection overlay stack 2 deposited over a non-transparent polymer injection base layer 0 under the scenario where the plastic injections to the mold or mold surfaces occur under minimal pressure and temperature at or near an injector gate. The illustrated result follows a mold injection operation without the applied invention where the distinct injection layers still bleed into one another and outside intended edge boundaries causing a lesser but still existing intermix remelt defect 9.

FIG. 1C depicts the result of a transparent polymer injection overlay stack 2 that is deposited over a non-transparent polymer injection base layer 0 after mold injections without the applied invention where the distinct injection layers bleed into one another and outside intended edge boundaries causing intermix remelt defect 9. The illustrated FIG. 1C scenario reflects injection to the mold or mold surface under moderately higher pressure and temperature levels at or near an injector gate where the distinct injection layers still bleed into one another and outside intended edge boundaries causing a varied but still existing intermix remelt defect 9.

FIG. 1D depicts the result of a transparent polymer injection overlay stack 2 deposited over a non-transparent polymer injection base layer 0 without the applied invention where the distinct injection layers bleed into one another and outside intended edge boundaries causing intermix remelt defect 9. The illustrated FIG. 1D scenario reflects the overlay results of distinct injection layers under moderate pressure and lesser temperature levels at or near an injector gate where the distinct injection layers still bleed outside and intermix across intended edge boundaries causing another varied remelt defect 9.

FIG. 1E depicts a sample result of a transparent polymer injection overlay stack 2 deposited over a non-transparent polymer injection base layer 0 applied with the inventive solution of a transparent polymeric insert 1 (illustratively embedded by dash line) between the operations of polymer injection base layer 0 and polymer injection overlay stack 2 where the solution prevents color bleed defects or composition intermixing to promote and maintain distinct edge boundary designs. The illustrated FIG. 1E scenario reflects repeatably consistent results under various pressure and temperature levels when applied at or near an injector gate location.

Depicted in FIG. 2A, one embodiment approach can be an injection mold product formed from a polymeric injection-molding operation at a station I along a mold surface S where strategically positioned injector gates 14 introduce polymeric material from supply point locations into a mold tool M or in conjunction with polymeric inserts 1 emplaced between multi-shot operations of plastic injection overlay stack 2 by injection-mold operations at the same station I or a different station II. Polymeric inserts 1 can be retained along a mold surface S implemented via a retention means like lines of vacuum 13, by example, while base layer 0 is formed. With such a retention means approach, polymeric inserts 1 can be strategically emplaced at designed locations upon base layer 0 formation and pressed onto base layer 0 with kinematic movements of mold operation 44. A polymeric insert 1 can be applied along injection-mold interfaces where remelt locations may be of concern by using thickness applications of about 1 mm thru 13 mm, but preferably with an application of 6 mm thickness.

Upon mold operation 44 that can bind constituents of polymeric insert 1 and base layer 0 together, the pending polymeric product can be displaced by mold station conveyance 33 to a station II where stack layer 2 can be applied by mold operation 44 to achieve polymeric product P. A resultant polymeric product P from a mold assembly M is then achieved by a system that can include a transparent, opaque or translucent polymeric compositions with in-situ polymeric inserts 1 emplaced between distinct polymeric injection layers of overlay stack 2 where transparent or clear polymeric layers can be overlaid along a non-transparent polymeric base layer 0 without occurrences of superficial melting of the base layer 0 or any adjacent surrounding sections during mold-injection operations. Mold station conveyance 33 can represent a means of displacing or re-orienting injection mold products P (that can represent P's state of process condition e.g. unprocessed stage P, partially processed P, unfinished P or fully processed P etc.) from one location to another location or can reference different stations where a distinguished applied process can occur. Mold operation 44 can represent the kinematic movements associated with the mold assembly M components (press, release, displacement, rotation, etc.) in the fabrication process of mold products P.

A conventional retention method 13 means any suitable device structure having the ability to keep or hold a component in-place within a mold enclosure M (by a non-destructive way) during injection stack operations can represent a mode to secure a polymeric insert 1 component in-place but a preferred method is to apply a vacuum-suction process 13 to secure a component in-place.

A vacuum retention means is any suitable method to apply vacuum pressure or applied sucking along a mold surface S in order to hold in place a part or component orientation securely in-position or along the mold M during manufacturing operations. Vacuum retention is typically implemented through the use of various pumps, actuated valves, air lines and controls in order to facilitate the activation, release and regulation of retention forces between the secured component and the mold surface S.

FIG. 2B depicts an exemplary detail of a cross-sectional polymeric stack that can result following fabrication via mold operation 44 where base layer 0 is deposited along a mold surface, followed by polymeric insert 1 emplacement and a deposited overlay stack 2 that encapsulates polymeric insert 1 between layers 0 and 2 to achieve mold product P. Polymeric inserts 1 can be formed of a clear or transparent polymeric material by preferred embodiment, but any suitable polymeric material can be used as a barrier at the base layer 0 and overlay stack 2 interface. In one embodiment, the polymeric insert 1 can be the same material as the overlay stack 2 material. In another embodiment, the polymeric insert 1 can be a different material from the base layer 0 or the overlay stack 2 material. An edge 15 of each polymeric insert 1 can be chamfered or can adopt tapered features in order to facilitate proper melding transitions and avoid interface voids with adjoining base layer 0 and overlay stack 2 or along edge interfaces between them. The non-limiting depiction of mold product P assumes that the sectional depiction 77 is free from decorative imprints or free of introduced patterns and merely illustrates an exemplary encapsulation of polymeric insert 1 with adjoining interface layers 0 and 2.

To supplement the details of an encapsulating operation of polymeric inserts 1, base layer 0 is overlaid onto a mold surface S once each pre-designed polymeric insert 1 is securely positioned onto a mold surface S that accounts for the position or orientation of any decorative imprint 4 edges and the encapsulation edge 6 such that an encapsulation region 7 can be sufficiently provided in a covering manner to avoid superficial melt occurrences. In an embodiment, encapsulation region 7 can encompass the base layer 0, the polymeric insert 1 and overlay stack 2. As illustrated by FIG. 2B, this encapsulation region 7 can cover over a pattern-free region 77 as well as a region of a decorative imprint 4. Where the encapsulation region 7 covers the encapsulation edge 6 and a pattern-free region 77, a material engagement between the materials of the base layer 0, the overlay stack 2 and of the encapsulation region is producible by the encapsulating operation, which has the effect of connecting the adjoining or interfacing layer portions firmly to each other.

FIG. 2A contemplates another embodiment where a polymeric injection mold product P can include any number of polymeric inserts 1 emplaced onto a mold surface S by either a vacuum or conventional retention method 13 and be encapsulated with a base layer 0 of a non-transparent plastic produced by injection-mold operation at a station I along a mold surface S that includes polymeric inserts 1 and then the mold product P can undergo a mold-injection operation of a transparent plastic at a different station II that builds overlay stack 2 upwardly off the base layer 0 with encapsulated polymeric inserts 1, where overlay stack 2 can represent a single or any number of deposited plastic layers that are either transparent or non-transparent polymeric material. Encapsulated regions enclosing each polymeric insert 1 can be formed along base layer 0 and overlay stack 2, which bind the materials together thermally or through chemical cure. FIG. 2B illustrates where an edge 15 of each polymeric insert 1 can be chamfered or can adopt tapered features in order to facilitate proper melding transitions and avoid interface voids with adjoining base layer 0 and overlay stack 2 or along edge interfaces between them.

In an alternate embodiment depicted by FIG. 2A, an injection mold product P can include polymeric inserts 1 positioned onto a mold surface S by a vacuum retention method 13 at one station operation I and then the mold product P can undergo another mold operation of a non-transparent plastic injection at the same station I that builds upwardly via an injection process off die-mold surface S with a base layer 0 encapsulating numbers of polymeric inserts 1 that extend from and off of die-mold surface S. Following an operation encapsulating the polymeric inserts 1, the mold product P can undergo additional mold-injection operations of transparent plastic at the same station I that builds upwardly off base layer 0 with encapsulated polymeric inserts 1 that further deposits and builds overlay stack 2 upwardly from off the base layer 0 plus polymeric insert 1 layup, where overlay stack 2 can represent a single or any number of deposited plastic layers that are either transparent or non-transparent polymeric material. As FIG. 2B details, encapsulated regions 7 enclosing each polymeric insert 1 can be formed along base layer 0 and overlay stack 2 with the adjoined materials bound together thermally or through chemical cure.

FIG. 2A also contemplates an alternate embodiment where a polymeric mold product P can be formed from an injection-molding operation at station I along a mold surface S that includes polymeric inserts 1 emplaced onto a mold surface S by either a vacuum or other conventionally available retention method and then the mold product P can undergo a mold-injection operation of a non-transparent plastic injection at a different station II that builds upwardly off die-mold surface S with a base layer 0 being deposited and encapsulating polymeric inserts 1 that extend from the die-mold surface S. Then the mold product P can undergo another mold-operation of transparent plastic injection at a different station II that builds overlay stack 2 upwardly off the base layer 0 with encapsulated polymeric inserts 1, where overlay stack 2 can represent a single or any number of deposited plastic layers that are either transparent or non-transparent polymeric material. Encapsulated regions enclosing each polymeric insert 1 can be formed between base layer 0 and overlay stack 2 with the adjoined materials bound together by thermal process or through chemical cure.

In yet another embodiment that FIG. 2A contemplates, a polymeric injection mold product P can include any number of polymeric inserts 1 emplaced onto a mold surface S by either a vacuum or other conventionally suitable retention means 13 and be encapsulated with a base layer 0 of a non-transparent plastic produced by an injection-mold operation at a station I along a mold surface S that includes polymeric inserts 1 and then the mold product P can undergo a mold-injection operation of a semi-transparent plastic at a different station II that builds overlay stack 2 upwardly off the base layer 0 with encapsulated polymeric inserts 1, where overlay stack 2 can represent a single or any number of deposited plastic layers that are either at least semi-transparent or non-transparent polymeric material. And as previously described, encapsulated regions 7 encompassing each polymeric insert 1 can be formed along base layer 0 and overlay stack 2 with the adjoined materials bound together by thermal process or through chemical cure.

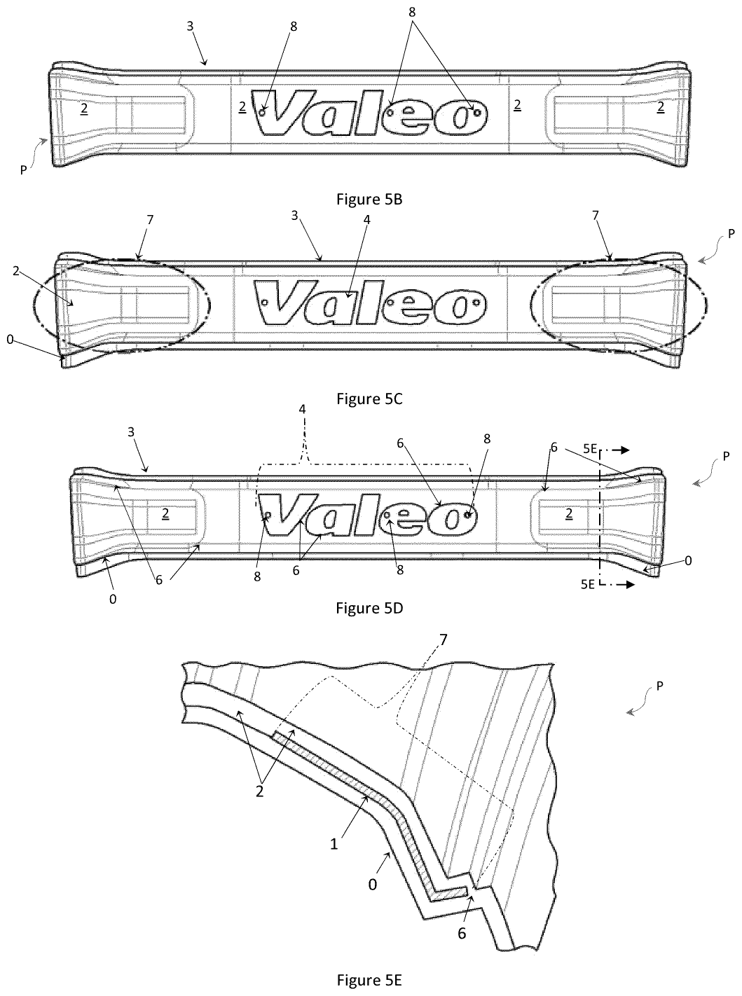

As illustrated by FIGS. 2B and 5E, the polymeric inserts 1 have the effect of insulating the distinct colored base layer 0 from being manipulated, either thermally or by pressure stresses, such that material from overlay stack 2 does not mix into, bleed nor become introduced into base layer 0 via contamination beyond the laminar interface or beyond the pre-designed laminar boundary. As illustrated in FIGS. 2 and 5A, each polymeric insert 1 can be positioned along encapsulation edges 6 between base layer 0 and overlay stack 2 where each polymeric insert 1 is designed with a sufficient overlap dimension such that the interface between base layer 0 and overlay stack 2 is insulated from being manipulated to cause cross layer contamination. Various shapes and patterns can be introduced Into base layer 0 by an imprint 4 within a peripheral boundary 3 of the injection mold product P. Each polymeric insert 1 can serve the purpose of a dam or barrier that insulates interfacing layers from the possible detrimental effects of gate injectors 14 that cause superficial melt or the formation of aberrations between the deposited interlaminar plies (0 and 2, for example) during injection operations.

FIGS. 2B, 5C and 5E can further help illustrate encapsulating operations with visual aids that depict where the base layer 0 can be placed into a mold tool M, for which purpose the base layer 0 can provide a peripheral boundary 3 shape for a pre-defined part-assembly P and serves as a platform for a overlay stack 2—the peripheral shape of mold product P that is pre-defined by boundary 3. Since the surface area of a polymeric insert 1 will typically be designed smaller than the stack layer 2, an encapsulated region enclosing each polymeric insert 1 can be formed along base 0 and overlapped by stack layer 2, which bind the materials together thermally or by chemical curing as depicted by example in FIG. 5E. An edge 15 of each polymeric insert 1 can be chamfered or can adopt tapered features in order to facilitate proper melding transitions and avoid interface voids with adjoining base layer 0 and overlay stack 2 or along edge interfaces between them.

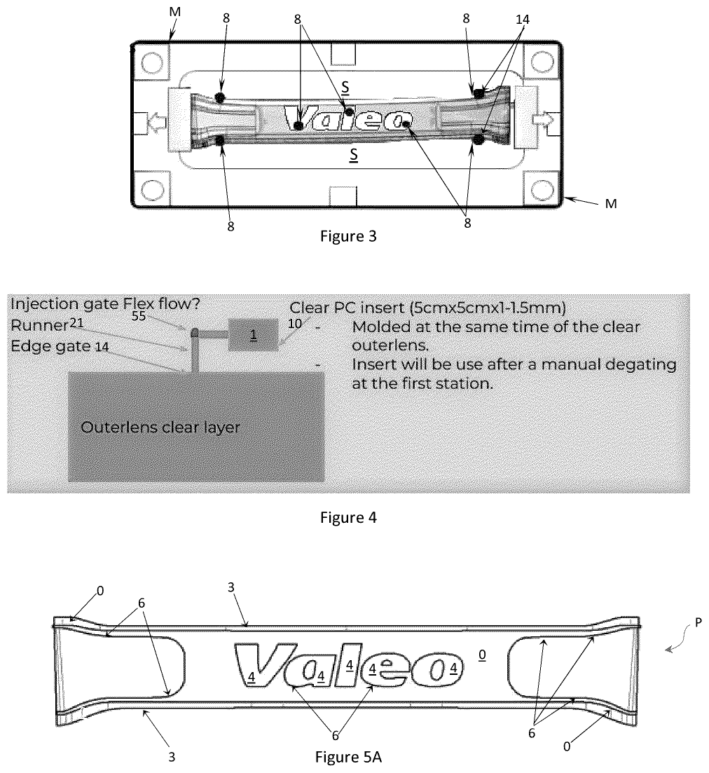

As depicted in FIG. 3, another approach can be an injection mold product P formed from a polymeric-based injection-molding operation at a station I along a mold surface S where strategically positioned injector gates 14 are oriented or located at positions that conceal defects or aberrations formed from or near the material ejecting from the tips of injector gates 14 along the viewable faces of an assembly structure. FIG. 3 illustrates an overhead planar overview of an injection mold product P within a mold enclosure M by non-limiting example. Mold M can represent a typical tool with associated assembly block and illustrative shape-formulating components that can properly achieve a completed mold product P. Mold surface S can represent a typical layup surface associated with the mold M that can be applied in the fabrication of mold product P. Prospective areas of aberration defects 8 (introduced by injector ports 14) can represent the locations for injector gates 14 that are strategically positioned such that potentially formed aberration defects 8 can be concealed or minimized from view. Injection-mold or shot material at each injector gate 14 can mitigate conspicuous defects by strategic placement of injector gates 14 on the mold product's P periphery or outside the conspicuous view of observers. That way, visible aberration defects 8 formed from the ejection material settling out from the mouths of the injector gates 14 can be visibly avoided or minimized.

Notably demonstrated placement of strategically oriented or located injector gates 14 can place any aberration defects 8 that materialize in positions that fall-out of view from the viewable perspectives of customers. Strategically oriented or located means that the pre-designed placement of injector gates 14 at any suitable angle, direction or orientation can facilitate concealment or resolution of visible defects along blind-side perspectives of an injection mold product P. Injector gate 14 can represent any suitable structure (nozzle, tube, nipple, orifice, etc.) that capably deposits a polymeric composition or mass via an orifice, nozzle injector tip or a type of gate that focuses and directs polymeric material to a particularized location by means of controlled mass flow.

FIG. 4 depicts an embodiment that can produce clear or transparent polymeric inserts 1 in conjunction with other transparent polymeric products based on the mutual use of injector gate 14 Infrastructure and similarly applied polymeric material. FIG. 4 Illustrates an embodiment for producing polymeric inserts 1 or transparent lens parts from the same polymeric material supply source 10 prospectively channeled to injector gate 14 through lines 21 and regulated by valve control 55 by a typical architecture associated with the implementation of the fabrication process. FIG. 4 depicts an interface of the injector gate 14 with runner lines 21, a flow control mechanism 55 and the material supply source 10 from the same polymeric material in order to fabricate polymeric insert 1 components and an outer-lens part (not shown) of a lighting module simultaneously.

FIG. 5A illustrates an overhead planar view following an injection operation of base layer 0 deposited on the surface S of mold M. The mold product P can include a decorative imprint 4 that depicts encapsulation edge 6 where polymeric inserts 1 can be placed prior to encapsulation by stack layer 2.

FIG. 5B illustrates an overhead planar view of injection operation overlay stack 2 deposited over base layer 0, decorative imprint 4 and polymeric inserts 1 that overcoat or wet extend through edge boundary 3 of mold product P. The mold product P can include a decorative imprint 4 that depicts encapsulation edge 6 where polymeric inserts 1 can be located prior to encapsulation region 7 by overlay stack 2. Upon encapsulation by overlay stack 2, the mold product P can result in regionally depicted encapsulation edges 6 where polymeric inserts 1 can be located prior to encapsulation region 7 at the illustrated locations in FIG. 5C to prevent remelt or inter-mixing between the colors of base layer 0 and overlay stack 2—to address the remelt problem or color-bleed material invasion as demonstrated by the Illustrated defects in FIGS. 1A-1D.

In depicted FIG. 5B embodiment, the polymeric injection mold product P, overlay stack 2 is deposited over the base layer 0 of FIG. 5A, which encompasses polymeric inserts 1 and any decorative imprints 4 along respective encapsulation edges 6, where overlay stack 2 can represent a single or any conceivable number of deposited layers that are either transparent or non-transparent polymeric material that can extend to peripheral boundary 3. The edges of each polymeric insert 1 can be chamfered or can adopt tapered features as reflected by taper edge 15 in order to facilitate proper melding transitions and avoid interface voids with adjoining base layer 0 and overlay stack 2 or along edge interfaces between them. The strategically oriented or located injector gates 14 can be located accordingly such that any resulting aberration defects 8 can materialize at decorative imprint 4 areas or along other feature areas of the mold product P where any such aberration defect 8 visibility can be concealed or avoided by casual observers.

FIG. 5C illustrates a multi-shot planform perspective of the injection operation of overlay stack 2 deposited over base layer 0, the imprint decoration 4 and polymeric inserts 1 that overlay encapsulation edge 6 where polymeric inserts 1 are located underneath depicted encapsulation region regions with the injection operation of stack layer 2. Mentioned again, taper edges 15 of each polymeric insert 1 can be chamfered or can adopt tapered features in order to facilitate proper melding transitions and avoid interface voids with adjoining base layer 0 and overlay stack 2 or along edge interfaces between them. The overlaid mold product P can include transparency to view base layer 0, an imprint decoration 4 or any transparency through the encapsulation region 7.

As illustrated in FIG. 5C and FIG. 5D that can represent exemplary embodiments of a mold product P, the encapsulation region 7 can exemplify clear or transparent features with the application of overlay stack 2 where the encapsulation region 7 is applied over base layer 0 along encapsulation edge 6. Furthermore, encapsulation region 7 can be clear or transparent over the decorative imprint 4 within any cutouts or sectioning of the base layer 0 that can extend along encapsulation edge 6. Injection mold operations resulting in the encapsulation region 7 can involve polymeric inserts 1 being enclosed by a encapsulation edge 6 of the base layer 0 to the extent necessary for fully encompassing over the encapsulation edge 6 so that the interfacing and adjoining layers remain fused together by the encapsulation region 7 and bind the material portions together through a thermal process or chemical cure means. Such that any lighting effect initiated from the background of the mold product P through decorative imprint 4 can be shown through and seen by an observer through a designed transparent overlay stack 2 and a transparent encapsulation region 7, for example.

FIGS. 5A-5E stage embodiments depict that encapsulation regions 7 by the overlay stack 2 that can extend beyond encapsulation edge 6 as pre-designed to prevent superficial melt or color-bleed between adjoining layers. While the FIG. 5D final stage embodiment can demonstrate Inclusion of overlay stack 2 to cover to the extent of encapsulation edge 6, which correlates with polymeric inserts 1 as included for the encapsulation region 7, such an encapsulation might not include the decorative imprint 4 for encapsulation if the encapsulation edge 6 is removed from the injection mold operation, which might not account for emplaced polymeric inserts 1 in the design.

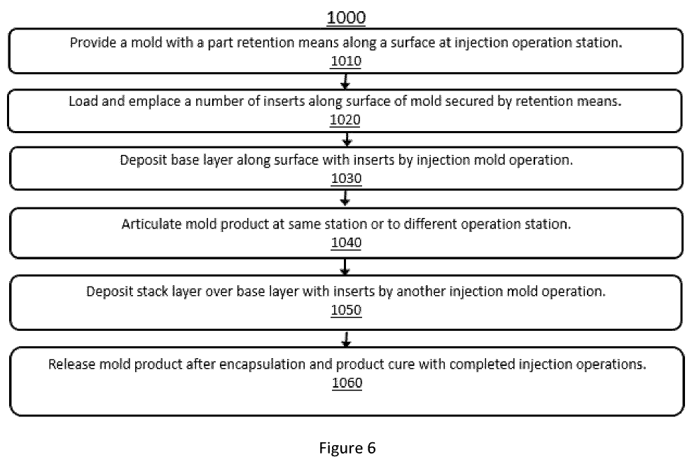

FIG. 6 illustratively depicts an embodiment of the invention and describes the process or method 1000 of a system that prevents superficial remelt during multi-injection polymeric fabrication operations. In method 1000, a polymeric multi-layer injection encapsulation system can bind together a base layer 0 with strategically located polymeric inserts 1 that are encapsulated by additional overlay stacks 2 of other plastic material layers by various mold operations along the injection gate 14 sites that remediate the superficial melting problems like from the associated aberration defects 8, by example accordingly.

Among the variable method embodiments for example, two blocks shown in succession may in fact be executed substantially concurrently or the associated blocks may sometimes be executed in the reverse order, depending upon the functionality involved. It will also be noted that each block of the block diagrams or flowchart illustration, and combinations of blocks in the block diagrams or flowchart illustration, can be implemented by both manual or automated systems that perform the specified functions or by acts or carry out combinations of special purpose hardware and control instructions.

In block 1010, a mold M injection apparatus with polymeric insert 1 can apply retention means 13 along an inner mold surface S provided at an injection operation station I. In block 1020, polymeric inserts 1 can be loaded along a mold surface S secured by vacuum retention means 13. In a non-limiting way, the operation station can represent the same operation station I or different operation station II. In block 1030, a mold product P can be initiated with an injection mold operation of non-transparent polymer of base layer 0 deposited along the mold surface S with emplaced polymeric inserts 1. In block 1040, a mold product P can be articulated or relocated to an operation station I or II for other injection operations. In block 1050, a transparent polymeric material overlay stack 2 can be deposited over base layer 0 with polymeric inserts 1 by another injection operation of the mold M. In block 1060, the mold product P can be released from the mold M upon cure and completion of injection-mold operations.

The method 1000 illustrates an embodiment of a system that remediates the superficial melt problem with associated defects that occur near injector gates 14 during multi-shot injection operations such that interfacial polymeric layers of the mold product P remain insulated, aberrant-free and preserve distinct color layer designs without invasive contamination. Therefore, light-transmissive lighting structures can be visibly enhanced with the production of defect-free injection molded products while satisfying market demands for expansive quality lighted structures, reduced environmental scrap waste and more cost-effective manufacturing.

It should be appreciated that the above referenced aspects and examples are non-limiting, as others exist within the present invention as shown and described herein. Unless stated otherwise, dimensions and geometries of the various structures depicted herein are not intended to be restrictive of the invention such that other dimensions or geometries are possible. Plural structural components can be provided by a single integrated structure. Alternatively, a single integrated structure might be divided into separate plural components.

In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The description set forth below as connected with the incorporated drawings are intended as a description of various embodiments of the disclosed subject matter and are not necessarily intended to represent any one select embodiment. In certain instances, the description can include specific details for purposes of providing an understanding of the disclosed embodiments. However, it will be apparent to those skilled in the art that the disclosed embodiments can be practiced without those specific details. In some instances, well-known structures and components can be shown in block diagram form in order to avoid obscuring concepts or design variations of the disclosed subject matter.

The stated plastic or polymeric injection material can be transparent, non-transparent, opaque or translucent material and can be extended to any portion of the molded product inclusive of the base, stack, insert, encapsulation or other incorporated sections, as is desired. The applied plastics material can vary with different degrees of hardness between the constituent injection operations. And in order to obtain greater freedom for shaping of the injection molded part, the incorporated injection operations include multi-shot encapsulation covers the base without a form fit, fastening of the encapsulation to the basic body takes place by the adhesion of the material engagement alone.

It is to be understood that terms such as “front,” “rear,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, and/or points of reference as disclosed herein, and likewise do not necessarily limit embodiments of the present disclosure to any particular configuration or orientation.

Furthermore, the terms “about,” “approximately,” “proximate,” “minor” and similar terms generally refer to ranges that include the identified value within a margin of 20 percent, 10 percent or preferably 5 percent in certain embodiments or any values therebetween.

In the field of automotive lighting, automakers seek to enhance the appearance of expansive multi-shot fabricated polymeric structures with light transmissive characteristics in order to eliminate or effectively conceal the visibly observable defects caused by uncontrolled injection methods and brought about by the superficial melting of the plastic during an encapsulation operation to reduce waste and mutually satisfy the aesthetic tastes of auto consumers that enhances the reflective reputation of manufacturer brands in a cost-effective way.

### LIST OF ELEMENT NUMBERS

Base layer 0
Polymeric insert 1
Overlay stack 2
Product edge boundary 3
Decorative imprint 4
Encapsulation edge 6
Encapsulation region 7
Aberration defect 8
Remelt defect 9
Mold product P
Mold tool M
Surface of mold S
Material supply source 10
Vacuum or alternative retention means 13
Injector gate/Injector port 14
Chamfer or taper edge 15
Vacuum line or runner line 21
Mold station conveyance 33
Mold operation 44
Valve metering control 55
Non-decorative or pattern-free region 77
1^{st} station I
2^{ND} station II

1. A system associated with a multi-shot polymeric injection process that prevents superficial melt between deposited interfacial color layers during fabrication of a mold product, comprising:
a mold that is configured to retain a number of polymeric inserts within the mold tool;
a number of injectors within the mold that are configured to deposit polymeric material, where a portion of said injectors are configured to deposit a base layer with said polymeric inserts;
where another portion of said injectors are configured to deposit an overlay stack of at least semi-transparent plastic such that an encapsulation region occurs of the base layer with said polymeric inserts and the overlay stack;
where the polymeric inserts are adapted to avoid remelt or color-mixing between adjoining interfaces with the base layer and the overlay stack of the mold product.

2. The system of claim 1, where said polymeric inserts are adapted to function as a barrier for fluidic shear forces to avoid intermixing of distinct color polymers along a number of interfaces between the base layer and the overlay stack of the mold product;

3. The system of claim 1, where the portion of said injectors configured to deposit the base layer is non-transparent plastic.

4. The system of claim 1, where the overlay stack is a number of polymeric layers deposited by said injectors that are at least semi-transparent or of a non-transparent polymeric composition extending to a peripheral edge boundary of the mold product.

5. The system of claim 1, where the number of injectors located within the mold are located along a number of surfaces.

6. The system of claim 1, where said polymeric inserts are secured in-place along a surface by a retention means.

7. The system of claim 6, where the mold includes a retention means that includes a network of vacuum lines integrated within the mold, which are configured to retain said polymeric inserts.

8. The system of claim 6, where the retention means is an electrostatic or adhesive-based method of retention.

9. The system of claim 7, where said vacuum lines are configured to retain said polymeric inserts along the number of surfaces within the mold.

10. The system of claim 1, where the polymeric material includes a non-transparent plastic deposited by a portion of said injectors.

11. The system of claim 1, where the polymeric inserts are adapted to prevent the cross-contamination of surrounding polymers beyond a laminar boundary at each insert interfacing at the base layer and the overlay stack.

12. The system of claim 7, where said polymeric inserts are secured in-place in a number of positions or orientations when a vacuum force is activated through the network of vacuum lines.

13. The system of claim 1, where a portion of said injectors are configured to deposit a transparent polymer composition that forms a portion of the overlay stack.

14. A method to prevent remelt along interfacial layers of a mold product during multi-injection operations of fabricating at least a semi-transparent structure, comprising:
presenting a mold that retains a number of polymeric inserts within the mold;
depositing a base layer of a non-transparent plastic that overlaps said polymeric inserts from a number of injector ports within the mold;
depositing an overlay stack over the base layer with said polymeric inserts, such that the polymeric inserts form a barrier between the interfacial plies of the base layer and the overlay stack are configured to prevent the appearance of aberration defects in the mold product or prevent superficial melting at interfaces with the base layer and the overlay stack or configured to avoid color bleed at interfaces deposited by said injectors of the mold product.

15. A polymeric product, comprising:
a base layer with an interface surface;
an overlay stack with the overlay stack being in contact with a portion of the interface surface;
a number of polymeric inserts positioned between the interface surface and the overlay stack where said polymeric inserts are configured to prevent melting of the base layer when the overlay stack is fabricated for the polymeric product.

16. The polymeric product of claim 15, where the base layer is a non-transparent or opaque plastic.

17. The polymeric product of claim 15, where the overlay stack is a number of polymeric layers that include at least semi-transparent, translucent or a transparent plastic extending to a peripheral edge boundary of the polymeric product.

18. The polymeric product of claim 15, where the polymeric insert is formed from a polymeric composition that is at least semi-transparent, translucent or transparent.

19. The polymeric product of claim 15, wherein at least one of the base layer and the overlay stack includes a number of decorative imprints.

20. The polymeric product of claim 15, wherein each polymeric insert is encompassed by an encapsulation region within the polymeric product.
